(19) United States
(12) Patent Application Publication
(10) Pub. No.: US 2016/0290335 A1
(43) Pub. Date: Oct. 6, 2016

(54) VARIABLE DISPLACEMENT LUBRICANT PUMP

(71) Applicant: PIERBURG PUMP TECHNOLOGY GMBH, Neuss (DE)

(72) Inventors: CARMINE CUNEO, PISA (IT); GIACOMO ARMENIO, LIVORNO (IT); MASSIMILIANO LAZZERINI, SAN PIETRO IN PALAZZI (IT)

(73) Assignee: PIERBURG PUMP TECHNOLOGY GMBH, NEUSS (DE)

(21) Appl. No.: 15/037,681

(22) PCT Filed: Nov. 21, 2013
(86) PCT No.: PCT/EP2013/074369

§ 371 Date: May 19, 2016

(51) Int. Cl. F04C 14/24; F04C 14/22; F01M 1/02; F02B 67/04

(52) U.S. Cl. CPC F04C 14/24; F02B 67/04; F04C 14/22; F01M 1/02; F01M 2001/0238; F01M 2001/0246; F01M 2001/0253

(57) ABSTRACT

A variable displacement lubricant pump includes a control ring, a pump rotor with radially-slidable vanes which rotate in the control ring, and a pressure control system to control a lubricant discharge pressure. The pressure control system includes a pressure control chamber which pushes the control ring into a high pumping volume direction, a pilot chamber which pushes the control ring into a low pumping volume direction, and a pressure control valve which controls a pressure in the pressure control chamber. The pressure control valve comprises a control port connected to the pressure control chamber, a control valve body which connects/disconnects the control port to atmospheric pressure, first and second valve chambers arranged at opposite ends of the control valve body, and a fluidic valve control line comprising a discharge valve which discharges the lubricant from the second valve chamber to atmospheric pressure.

### CROSS REFERENCE TO PRIOR APPLICATIONS

This application is a U.S. National Phase application under 35 U.S.C. §371 of International Application No. PCT/EP2013/074369, filed on Nov. 21, 2013. The International Application was published in English on May 28, 2015 as WO 2015/074700 A1 under PCT Article 21(2).

### FIELD

The present invention relates to a mechanical variable displacement lubricant pump for providing a pressurized lubricant for an internal combustion engine.

### BACKGROUND

The mechanical lubricant pump is mechanically driven by the engine. The lubricant pump is fluidically coupled to the combustion engine to pump a pressurized lubricant to and through the engine.

WO 2012/113437 describes a variable lubricant pump with a pump rotor with radially slidable vanes which rotate inside a shiftable control ring, which is radially shiftable or pivotable with respect to the rotor axis between a high pumping volume position with high eccentricity, and a low pumping volume position with low or no eccentricity of the control ring with respect to the rotational rotor axis. The pump is provided with a pressure control system to control the discharge pressure of the pressurized lubricant at the pump outlet. The pressure control system comprises a fluidic pressure control chamber to push the shiftable control ring into a high pumping volume direction with a high control ring eccentricity. The pressure control system also comprises a fluidic pilot chamber to push the control ring into a low pumping volume direction against the forces generated by the pressure control chamber. The pressure control chamber is an antagonist of the pilot chamber. The pilot chamber as well as the control chamber are fluidically directly connected to the discharge pressure.

The pressure control chamber is also fluidically connectable to atmospheric pressure via a pressure control valve which controls the pressure in the pressure control chamber. The pressure control valve is provided with a control valve plunger to open and close a control port of the control valve. The control port of the pressure control valve is connected to an outlet of the pressure control chamber so that the pressure control chamber is connected to atmospheric pressure in the low discharge pressure position of the pressure control valve. The low discharge pressure valve position is the minimum eccentricity valve position. In the high discharge pressure position of the pressure control valve, which is the maximum control ring eccentricity position, the pressure control chamber is only connected to the discharge pressure. This control arrangement provides short fluidic paths so that the control quality and control stability is good. The control quality of this control arrangement is not satisfying under disadvantageous conditions, for example, if a considerable volume of air is present in the lubricant.

WO 2012/113 437 A1 and U.S. Pat. No. 2,740,256 both describe a mechanical variable displacement lubricant pump with a control valve whose shiftable control valve body is pushed by a valve spring into the high discharge pressure valve position. The support basis of the valve spring is hydraulically shiftable within a small range to preload the valve spring so that a second level of discharge pressure can be selected.

### SUMMARY

An aspect of the present invention is to provide a variable displacement lubricant pump with a simple pressure control system which allows for the selection of different discharge pressure levels.

In an embodiment, the present invention provides a variable displacement lubricant pump which is fluidically connected to and mechanically driven by an internal combustion engine and which is configured to pump a pressurized lubricant with a lubricant discharge pressure to the internal combustion engine. The variable displacement lubricant pump includes a control ring configured to be radially shiftable or pivotable with respect to a rotor axis between a high pumping volume position with a high control ring eccentricity with respect to the rotor axis and a low pumping volume position with a low control ring eccentricity of the control ring with respect to the rotor axis, a pump rotor comprising vanes configured to be radially slidable and to rotate in the control ring, and a pressure control system configured to control the lubricant discharge pressure. The pressure control system comprises a pressure control chamber configured to be chargeable with the lubricant discharge pressure to push the control ring into a high pumping volume direction, a pilot chamber configured to be chargeable with the lubricant discharge pressure to push the control ring into a low pumping volume direction against the pressure control chamber, and a pressure control valve configured to control a pressure in the pressure control chamber. The pressure control valve comprises a control port connected to the pressure control chamber, a control valve body configured to be shiftable to connect or disconnect the control port to atmospheric pressure, a first valve chamber arranged at a first longitudinal end of the control valve body, a second valve chamber arranged at a second longitudinal end of the control valve body, and a fluidic valve control line comprising a discharge valve configured to discharge the lubricant from the second valve chamber to atmospheric pressure. The first valve chamber is directly charged with the discharge pressure. The first valve chamber, when pressurized, is configured to push the control valve body into a low discharge pressure position against the second valve chamber, when pressurized.

### BRIEF DESCRIPTION OF THE DRAWINGS

The present invention is described in greater detail below on the basis of embodiments and of the drawings in which:

FIG. 1 shows a first embodiment of a variable displacement lubricant pump together with an internal combustion engine, wherein the pump is provided with a control valve to define the lubricant pressure in the control chamber, the control valve being in the high discharge pressure position so that the pressure in the control chamber of the pump is equal to the pump's discharge pressure pd;

FIG. 2 shows the arrangement of FIG. 1 with the control valve in the low eccentricity position so that the pressure in the control chamber of the pump is equal to atmospheric pressure pa;

FIG. 3 shows a second embodiment of a variable displacement lubricant pump together with an internal combustion engine, wherein the pump is provided with a control valve to define the lubricant pressure in the control chamber as well as in the pilot chamber of the pump, the control valve being in a high discharge pressure position so that the pressure in the control chamber is equal to the discharge pressure pd and the pressure in the pilot chamber is equal to atmospheric pressure pa;

FIG. 4 shows the embodiment of FIG. 3 with the control valve in a medium discharge pressure position so that the pressure in the control chamber and in the pilot chamber is between the discharge pressure pd and the atmospheric pressure pa;

FIG. 5 shows the arrangement of FIG. 3 with the control valve in a low discharge pressure position so that the pressure in the control chamber is equal to the atmospheric pressure pa, and the pressure in the pilot chamber is equal to the discharge pressure pd; and

FIG. 6 shows a third embodiment of a control valve with a discharge valve selectively connecting the second valve chamber to atmospheric pressure pa or to discharge pressure pd.

### DETAILED DESCRIPTION

The pressure control valve of the lubricant pump according to the present invention is provided with a shiftable control valve body which is directly pushed from both sides by the lubricant pressure in a first valve chamber and in a counteracting second valve chamber. The first valve chamber at a first longitudinal end of the pressure control valve can be directly charged by the discharge pressure pd of the lubricant pump. If the shiftable control valve body is pushed by the lubricant pressure in the first valve chamber into the low discharge pressure direction, the shiftable control valve body fluidically connects the valve control port directly connected to the pressure control chamber to atmospheric pressure pa so that the eccentricity of the control ring is reduced with the effect that the pump's discharge pressure is also reduced accordingly.

A second valve chamber is provided at the other longitudinal valve end of the control valve which counteracts against the first valve chamber. The second valve chamber is also fluidically connectable to the discharge pressure pd of the pump. The pressurized second valve chamber pushes the control valve body into a closed position in which the control valve body closes the connection of the control port to atmospheric pressure pa. The pressure in the control chamber is consequently raised up to the discharge pressure pa, and the control ring is pushed into the high eccentricity direction.

A fluidic valve control line is provided to discharge the lubricant from the second valve chamber to atmospheric pressure pa. The fluidic valve control line is provided with a discharge valve which allows the valve control line to be completely opened or completely closed to thereby control the pressure in the second valve chamber between the discharge pressure pd and the atmospheric pressure pa. The pressure force generated by the lubricant in the second valve chamber can be controlled stepwisely or steplessly. This simple and cost-effective arrangement allows different levels of the pump's discharge pressure to be defined.

The level of the pump's discharge pressure can be adapted to pressure needs under special circumstances, for example, when the engine is started, when the engine is cold, when the engine is warm, or when the highest pump rate of the lubricant pump is needed independent of all other conditions. Since the pump's pumping performance can be adapted in three or more steps, it is also possible to adapt the pump performance to minimize the engine's fuel consumption.

The lowest available pressure is applied to the second control chamber when the discharge valve is open and the valve control line connects the second valve chamber to atmospheric pressure pa. This leads under all circumstances to a closed control port so that the fluid pressure in the control chamber is erased to the discharge pressure pd. The control ring is consequently forced into the maximum pumping volume direction to its maximum eccentricity so that a maximum pumping volume of the pump is selected. The control of a constant discharge pressure pd is switched off. It can be necessary under special circumstances to force the control ring to a maximum eccentricity and a maximum discharge pressure pd independent of the other parameters and circumstances. Especially if too much air is present in the lubricant, it can be necessary to switch the pump into the maximum eccentricity condition to avoid having sufficient lubrication of the engine, pump vibration, and pump noise.

In an embodiment of the present invention, a valve spring can, for example, be provided within the second the valve chamber to pretension the control valve body into the high discharge pressure position. The valve spring in the second theft chamber defines the level of the control of discharge pressure and provides a failsafe configuration of the pressure control valve. If the discharge valve in the valve control line is open, and the second valve chamber is therefore connected to atmospheric pressure pa, the control valve body is pushed by the valve spring into a closed position against the pressure force in the first valve chamber.

In an embodiment of the present invention, a connection channel can, for example, be provided within the control valve body to directly connect the first valve chamber with the second valve chamber. The connection channel in the control valve body is a simple, reliable and inexpensive way to provide the discharge pressure to the second valve chamber. A fluidic throttle can, for example, be provided in the connection channel in the control valve body. The connection channel throttle allows different pressure levels to be defined in the second theft chamber, whereby the total lubricant flow and the lubricant loss to the second valve chamber and through the open discharge valve is reduced to a minimum.

In an embodiment of the present invention, the discharge valve can, for example, be an electrical valve which is electrically controlled by a control unit. The control unit can have information about the lubricant temperature, the engine temperature, the total discharge pressure, and/or other relevant parameters. The control unit can define a discharge pressure pd dependent on set parameters. The discharge valve can, for example, be a proportional valve which allows different lubricant pressure levels to be defined in the second valve chamber.

In an embodiment of the present invention, the piston area of the control valve body in the first valve chamber can, for example, be larger than the piston area in the second valve chamber.

In an embodiment of the present invention, the pilot chamber can, for example, be directly charged with the discharge pressure pd.

The pilot chamber can alternatively be charged with the discharge pressure pd via a passage in the control valve body and via a pilot port of the pressure control valve. The pilot port can, for example, be an opening in the control valve housing or cylinder. The pilot chamber is charged with the discharge pressure pd in the low discharge pressure position of the control valve body. In the high discharge pressure position of the control valve body, the pilot chamber is charged with the atmospheric pressure pa via the passages. The control chamber can, for example, also be charged with the discharge pressure pd via a separate passage in the control valve body and the control port. In the high discharge pressure position of the control valve body, the passage and the control port are fluidically in-line with each other and therefore define an open valve so that the control chamber is loaded with the discharge pressure pd. In the low discharge pressure position of the control valve body, the passage and the control port are not in-line with each other so that the control chamber is not loaded with the discharge pressure pd, but is loaded with the atmospheric pressure pa which is applied to the control port.

In an embodiment of the present invention, the control valve body can, for example, have a medium discharge pressure position in which the control port is connected to the discharge pressure pd as well as to the atmospheric pressure pa. A pressure between the discharge pressure pd and the atmospheric pressure pa can be defined in the control chamber in the medium discharge pressure position of the control valve body. This allows a medium level of set discharge pressure pd of the pump to be defined. The control valve body can alternatively or additionally have a medium discharge pressure position in which the pilot port is connected to the discharge pressure pd as well as to the atmospheric pressure pa. In the medium discharge pressure position of the control valve body, a pressure between the discharge pressure pd and the atmospheric pressure pa can be defined in the pilot chamber. This allows another medium level of set discharge pressure pd of the pump to be defined.

In an embodiment of the present invention, the piston area of the control chamber can, for example, be larger than the piston area of the pilot chamber.

In an embodiment of the present invention, the control ring can, for example, be pretensioned by a pretension spring into the high pumping volume direction. The pretension spring is an antagonist of the pilot chamber and can, for example, be arranged within the control chamber.

Two embodiments of the present invention are described below with reference to the drawings.

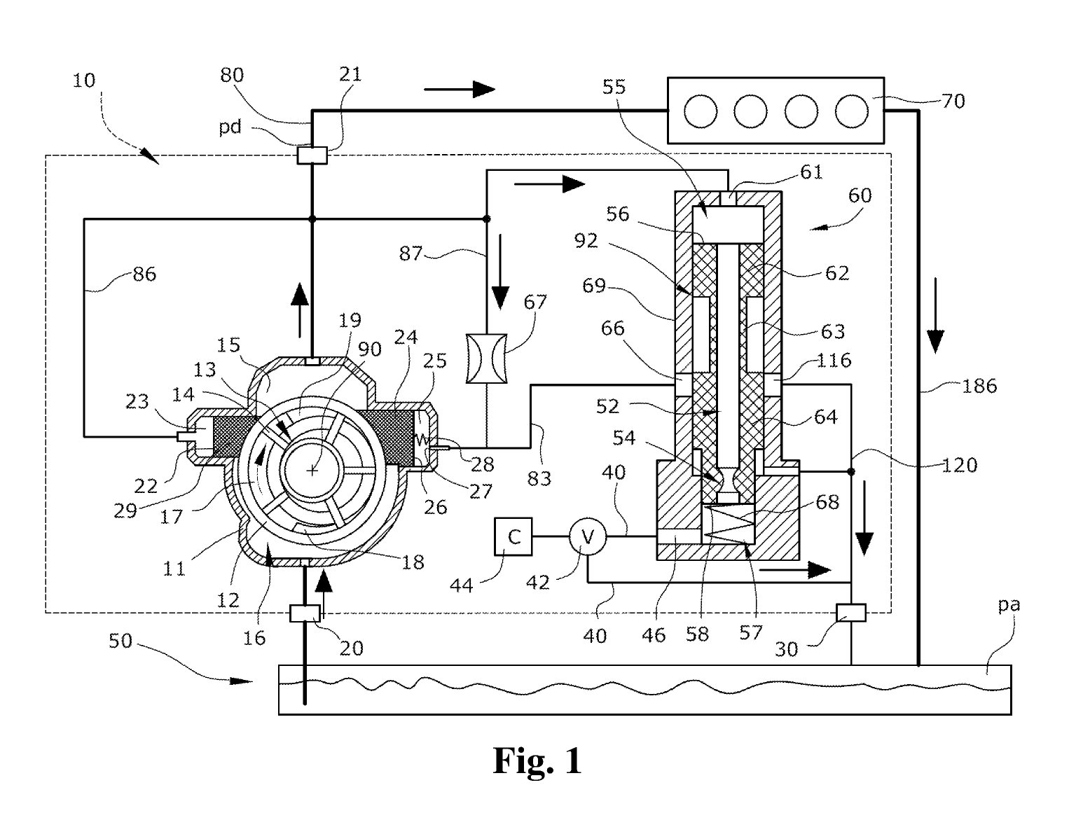

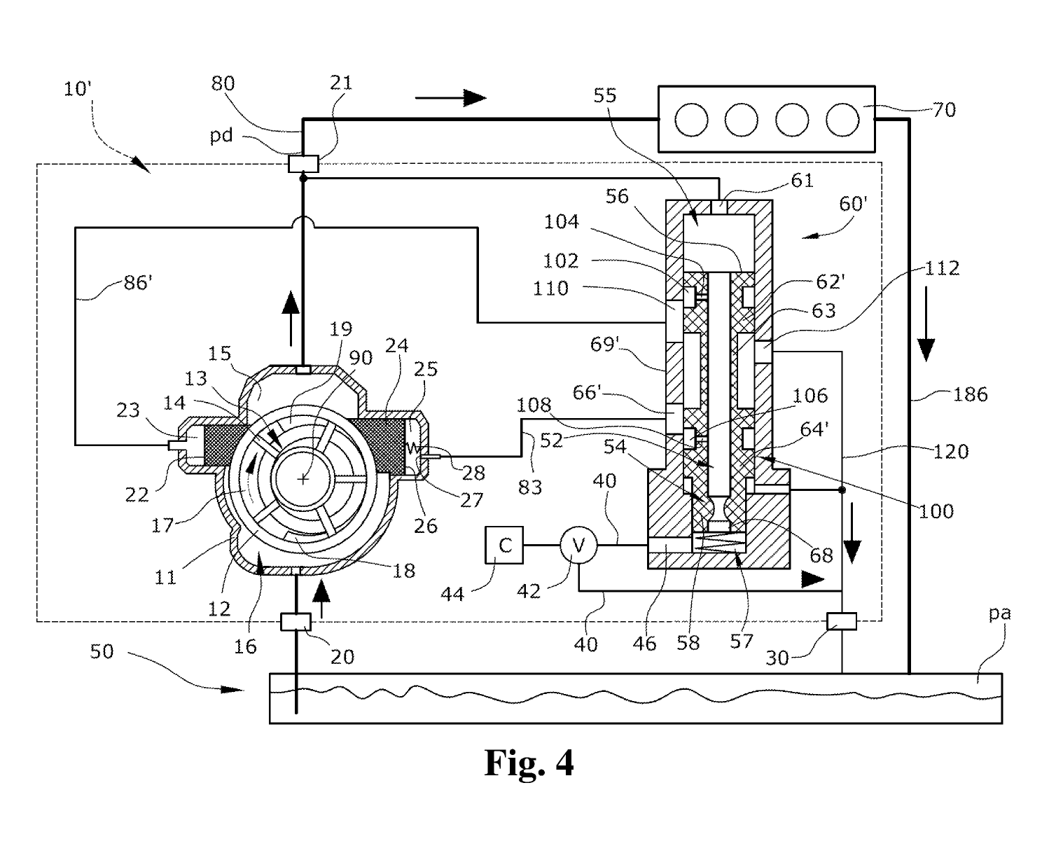

FIGS. 1 to 6 show schematic representations of a lubricant circuit arrangement including a variable displacement lubricant pump 10;10′ and an internal combustion engine 70, both together representing the relevant elements of the lubricant circuit. The lubricant pump 10;10′ is mechanically driven by the engine 70 so that the rotational speed of the lubricant pump 10;10′ is proportional to the rotational speed of the engine 70. The lubricant pump 10;10′ sucks lubricant from a lubricant tank 50 through a pump inlet 20 and pumps pressurized lubricant with a discharge pressure pd through a pump outlet 21 and a lubricant supply line 80 to the engine 70. The lubricant flows from the engine 70 through a return line 186 back to the lubricant tank 50 where the lubricant is under atmospheric pressure pa.

The pump 10;10′ comprises a pump housing 11 defining a cavity 16 wherein a pump rotor 13 with radially slidable vanes 14 rotates within a shiftable control ring 12. The pump housing 11 is closed by two pump side walls 15 (of which one is not shown in the drawings). The pump side walls 15, the vanes 14, the pump rotor 13, and the control ring 12 define five rotating pump chambers 17. One of the pump side walls 15 is provided with a pump chamber inlet opening 18 and with a pump chamber outlet opening 19 through which the lubricant flows into the rotating pump chambers 17 and out of the rotating pump chambers 17.

The control ring 12 is linearly shiftable in a radial direction so that the eccentricity of the control ring 12 with respect to the rotation axis 90 of the pump rotor 13 can be set to thereby shift the control ring 12 between a low pumping volume position with low eccentricity and a high pumping volume position with high eccentricity, as shown in the drawings.

The control ring 12 is provided with a control chamber plunger 24 housed in part in a pressure control chamber 25 and is provided with a pilot chamber plunger 29 housed in part in a pilot chamber 23 opposite to the pressure control chamber 25. The pressure control chamber 25 and the pilot chamber 23 are defined by the pump housing 11 and are antagonists. The control ring 12 and the plungers 29, 24 are one single integral part. The piston area 26 of the control chamber plunger 24 is larger than the piston area 22 of the pilot chamber plunger 29.

The control ring 12 is mechanically pretensioned by a pretension spring 28 located inside the pressure control chamber 25 into the high pumping volume direction. The pretension spring 28 and the pressure control chamber 25 both are antagonists of the pilot chamber 23.

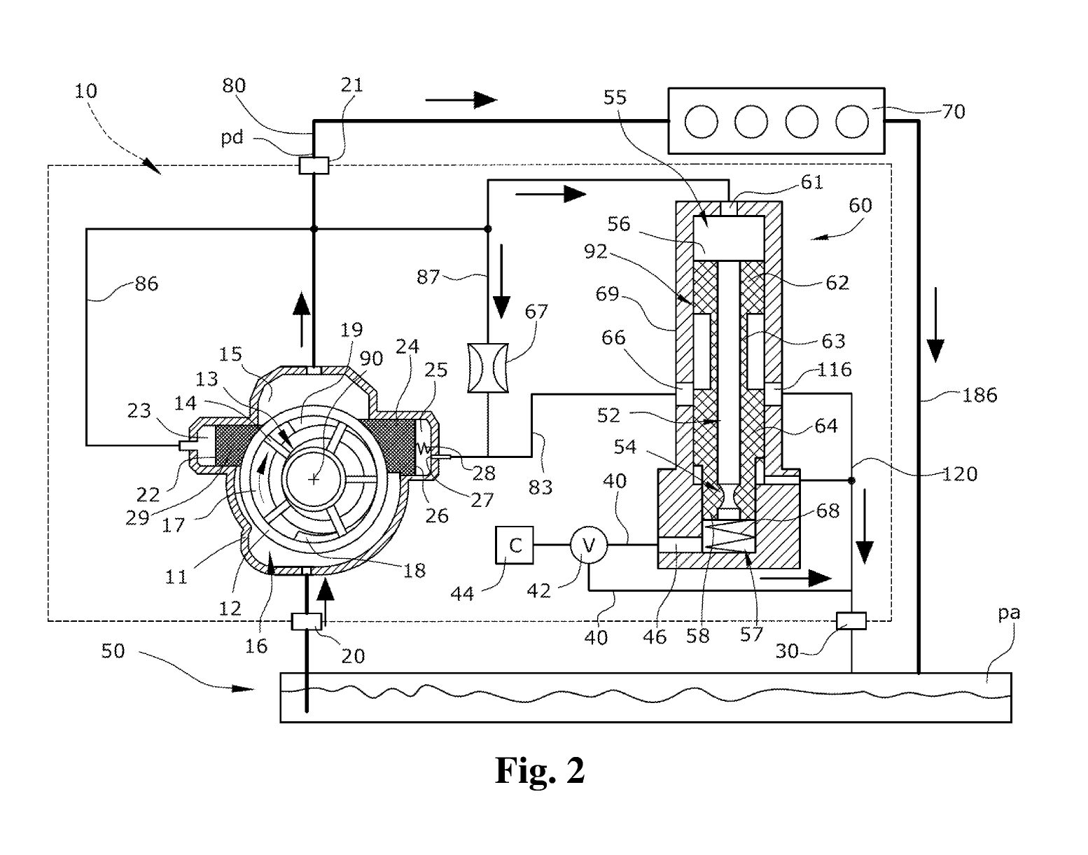

Referring to the first embodiment shown in FIGS. 1 and 2, the pressure control chamber 25 is directly fluidically connected by an internal pressure line 87 including a pressure throttle valve 67 with the discharge pressure pd. The lubricant can flow through the internal pressure line 87 via the pressure throttle valve 67 and through a control chamber inlet 27 into the pressure control chamber 25 so that a calibrated pressure drop occurs at the pressure throttle valve 67 if the lubricant flows through the pressure throttle valve 67. If the lubricant is not flowing through the internal pressure line 87, the lubricant pressure inside the pressure control chamber 25 is more or less equal to the discharge pressure pd. In the pressure control chamber 25, a pretension spring 28 is provided to pretension the control chamber plunger 24 and the control ring 12 into a high pumping volume direction. The pilot chamber 23 is directly pressurized through an connection line 86 with the discharge pressure pd of the pump 10.

The lubricant pressure in the pressure control chamber 25 is basically controlled by a pressure control valve 60. The pressure control valve 60 is provided with a control port 66 which is directly connected to the control chamber inlet 27 and with an atmospheric port 116. The atmospheric port 116 is connected via an internal lubricant line 120 to a valve discharge port 30 of the pump 10. The valve discharge port 30 is connected to the lubricant tank 50 which is under atmospheric pressure pa. The pressure control valve 60 connects the control chamber inlet 27 to atmospheric pressure pa when the control valve 60 is open so that the pressure in the pressure control chamber 25 is below the discharge pressure pa. If the pressure control valve 60 is completely open, the pressure drop at the pressure throttle valve 67 is extreme so that the liquid pressure in the pressure control chamber 25 is equal or close to the atmospheric pressure pa. If the control chamber is not completely open, the liquid pressure in the pressure control chamber 25 is somewhere between the discharge pressure pd and atmospheric pressure pa.

The pressure control valve 60 is provided with a control valve housing 69 with a shiftable control valve body 92 which is provided with a first valve body part 62 defining a first plunger, a second valve body part 64 defining a second plunger, and a plunger shaft 63 which mechanically connects the first valve body part 62 and the second valve body part 64. The control valve body 92 is provided to shift between an open position as shown in FIG. 2 and a closed position shown in FIG. 1. In the open valve position, the pressure control chamber 25 is fluidically connected via the control chamber inlet 27, a connection channel 83, the control port 66, and the valve discharge port 30 with the lubricant tank 50 which is always under atmospheric pressure pa.

The position of the control valve body 92 is determined by a control valve pretension spring 68 which pretensions the control valve body 92 into the closed position, by the fluidic pressure acting on the first valve body part 62 at one longitudinal valve body end into the open position, and the fluidic pressure acting on the second valve body part 64 at the other valve body longitudinal end into the closed position. Both valve body parts 62, 64 respectively define a cylindrical plunger within the control valve housing 69. Both body valve body parts 62, 64 are connected by the plunger shaft 63 which is smaller in diameter than the inner circumference of the control valve housing 69. The control valve housing 69 and a piston area 56 of the first valve body part 62 define a first valve chamber 55. The control valve housing 69 and the piston area 58 of the second valve body part 64 define a second valve chamber 57. The first valve body part piston area 56 is larger than the second valve body part piston area 58.

The first valve chamber 55 is directly pressurized with the discharge pressure pd via a first valve chamber port 61.

The closed valve position of the pressure control valve 60 is defined as the high eccentricity position, and the open valve position is defined as the low eccentricity position. The high eccentricity valve position shown in FIG. 1 is another expression for the high discharge position of the pressure control valve 60. The low eccentricity valve position shown in FIG. 2 is another expression for the low discharge pressure position.

The control valve body 92 is provided with a longitudinal connection channel 52 which fluidically connects the first valve chamber 55 with the second valve chamber 57. The connection channel 52 is provided with a fluidic throttle 54 to throttle the liquid current flowing through the connection channel 52 from the first valve chamber 55 to the second valve chamber 57.

The second valve chamber 57 is provided with a discharge port 46 which is fluidically connected to the atmospheric pressure pa of the lubricant tank 50 via a valve control line 40 with an electric discharge valve 42. The discharge valve 42 is controlled by a control unit 44 which controls the discharge valve 42 dependent on the discharge pressure pd, the rotational speed of the pump 10, and of the lubricant temperature. The discharge valve 42 can generally be a two-point valve, but can, for example, also be a proportional valve. If the discharge valve 42 is completely closed, the pressure in the second valve chamber 57 is more or less equal to the discharge pressure pd which is charged by the first valve chamber 55 and the connection channel 52. If the discharge valve 42 is opened gradually or completely, the liquid pressure in the second valve chamber 57 is between the discharge pressure pd and atmospheric pressure pa or is equal to the atmospheric pressure pa.

In critical situations, the control unit 44 completely closes the discharge valve 42 so that the control valve body 92 is forced into the closed position by the discharge pressure pd in the second valve chamber 57 and the pretension spring 68 so that the control port 66 is closed and the pressure in the pressure control chamber 25 is raised to the discharge pressure pd with the consequence that the control ring 12 is forced into the high pumping volume position. In the high pumping volume position, the pump 10 is forced to pump with the highest possible available volumetric performance.

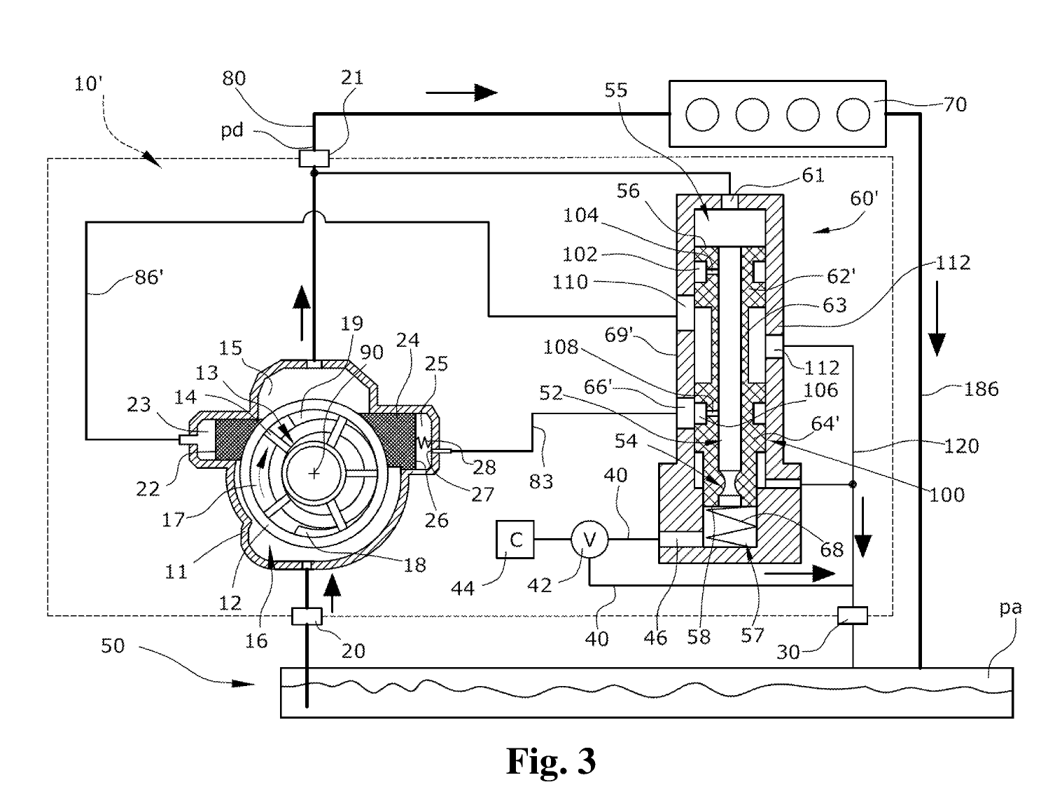

In the second embodiment shown in FIGS. 3 to 5, the pressure control chamber 25 as well as the pilot chamber 23 are both charged with liquid pressure only by the pressure control valve 60′. The pressure control chamber 25 and the pilot chamber 23 are not charged by an author channel, and are not directly charged with the discharge pressure pd of the pump 10′.

The control valve body 100 is additionally provided with a radial passage 104 to radially connect the longitudinal connection channel 52 with a circumferential plunger pilot port 102 at the outer surface of the first valve body part 62′. The control valve housing 69′ is provided with a housing pilot port 110 of which the longitudinal extent is larger than the longitudinal extent of the plunger section between the circumferential plunger pilot port 102 and the plunger shaft 63.

The control valve body 100 is also additionally provided with a radial passage 108 to radially connect the longitudinal connection channel 52 with a circumferential plunger control port 106 at the outer surface of the second valve body part 64′. The control valve housing 69′ is provided with the control port 66′ of which the longitudinal extent is larger than the longitudinal extent of the plunger section between the circumferential plunger control port 106 and the plunger shaft 63.

In the high pumping volume position of the pressure control valve 60′ shown in FIG. 3, the pilot chamber 23 is only connected to atmospheric pressure pa via a connection line 86′, the housing pilot port 110 in the control valve housing 69′, the cavity inside the control valve housing 69′ around the plunger shaft 63, and the outlet port 112 of the pressure control valve 60′. In this control valve position, the pressure control chamber 25 is connected to the discharge pressure pd via the radial connection channel 52, the radial passage 108, the circumferential plunger control port 106 of the control valve body 100, and via the control port 66′.

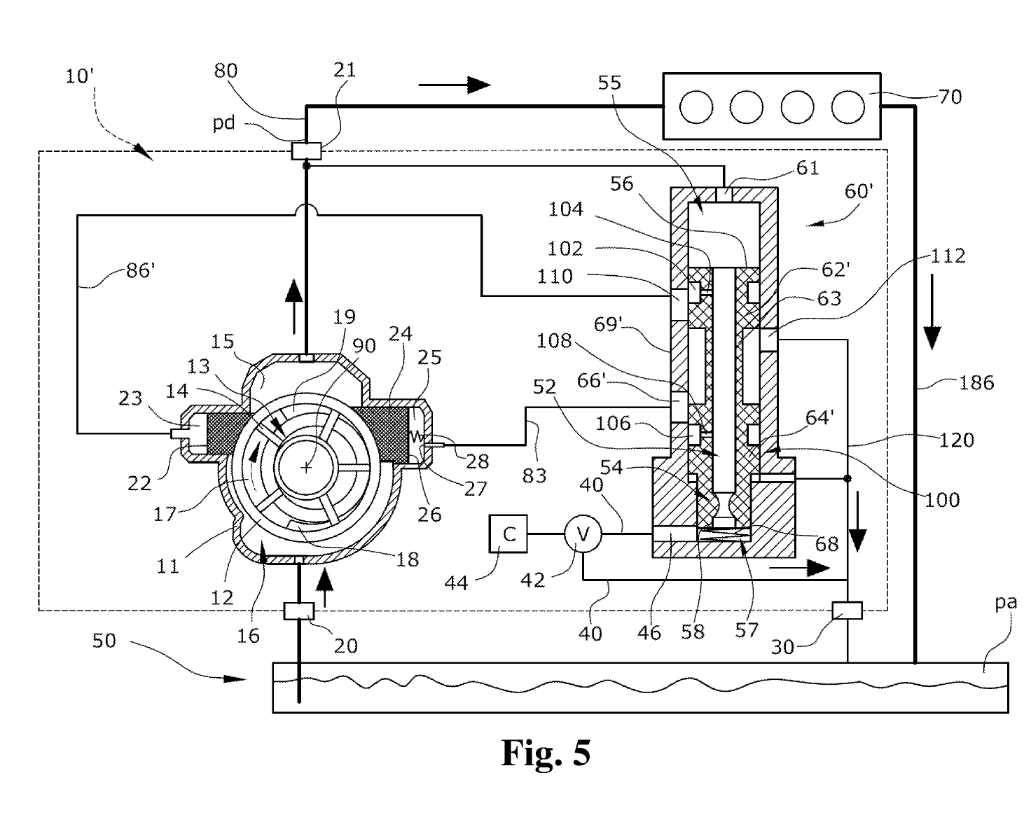

In the low pumping volume position of the pressure control valve 60′ shown in FIG. 5, the pilot chamber 23 is only connected to the discharge pressure pd via the connection channel 52, the radial passage 104, and the circumferential plunger pilot port 102 of the control valve body 100, and via the housing pilot port 110. In this control valve position, the control chamber is connected only to the atmospheric pressure pa via the control port 66′, the cavity inside the control valve housing 69′ around the plunger shaft 63, and the outlet port 112 of the pressure control valve 60′.

In the medium discharge pressure position of the control valve body 100, the pilot chamber 23 as well as the pressure control chamber 25 are connected to the discharge pressure pd as well as to atmospheric pressure pa so that in the pilot chamber 23 as well as in the pressure control chamber 25 a liquid pressure between the discharge pressure pd and the atmospheric pressure pa is present.

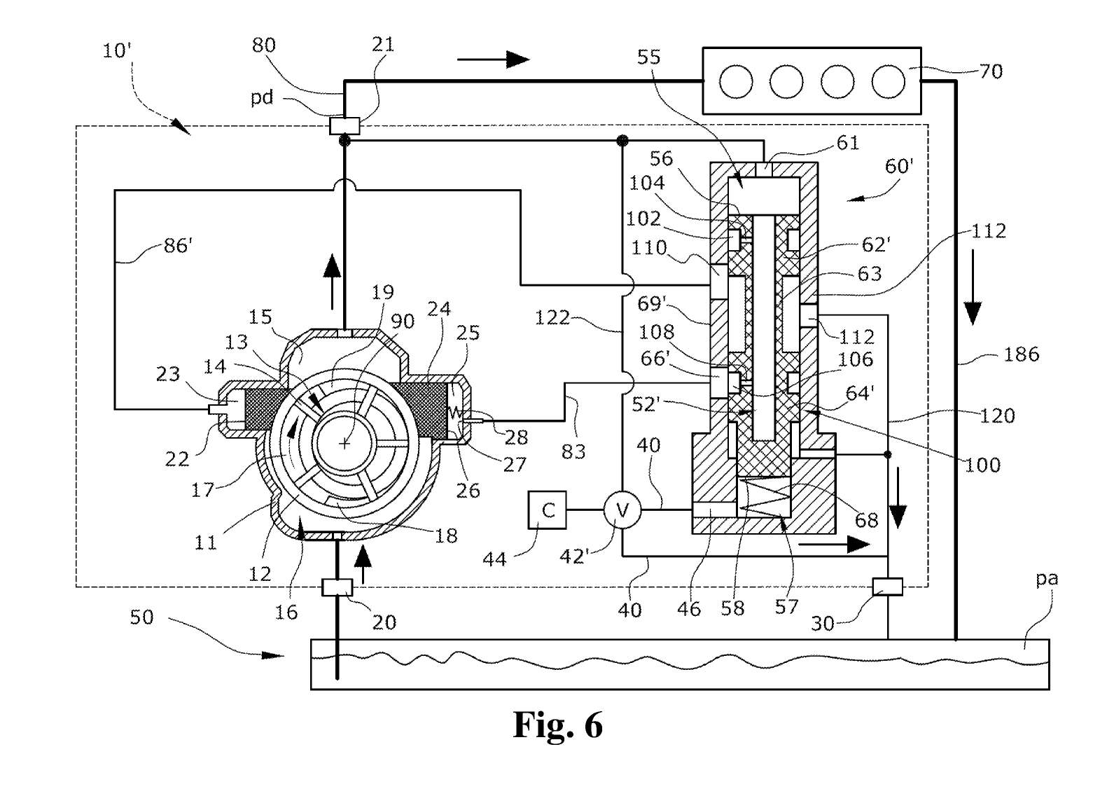

The pump 10′ in the third embodiment shown in FIG. 6 is based on the second embodiment shown in FIGS. 3 to 5. In contrast to the embodiments shown in FIGS. 1 to 5, the connection channel 52′ is here not connecting the first valve chamber 55 with the second valve chamber 57. The discharge valve 42′ is alternatively a two/three valve which alternatively connects the second valve chamber 57 with atmospheric pressure pa via fluidic valve control line 40 or with the discharge pressure pd via a connection line 122.

This arrangement of the pressure control valve 60′ and the discharge valve 42 can also be applied in the first embodiment shown in FIGS. 1 to 3.

The present invention is not limited to embodiments described herein; reference should be had to the appended claims.

What is claimed is:

1-14. (canceled)

15. A variable displacement lubricant pump fluidically connected to and mechanically driven by an internal combustion engine configured to pump a pressurized lubricant with a lubricant discharge pressure to the internal combustion engine, the variable displacement lubricant pump comprising:
a control ring configured to be radially shiftable or pivotable with respect to a rotor axis between a high pumping volume position with a high control ring eccentricity with respect to the rotor axis and a low pumping volume position with a low control ring eccentricity of the control ring with respect to the rotor axis;
a pump rotor comprising vanes configured to be radially slidable and to rotate in the control ring;
a pressure control system configured to control the lubricant discharge pressure, the pressure control system comprising:
a pressure control chamber configured to be chargeable with the lubricant discharge pressure to push the control ring into a high pumping volume direction,
a pilot chamber configured to be chargeable with the lubricant discharge pressure to push the control ring into a low pumping volume direction against the pressure control chamber, and
a pressure control valve configured to control a pressure in the pressure control chamber, the pressure control valve comprising,
a control port connected to the pressure control chamber,
a control valve body configured to be shiftable to connect or disconnect the control port to atmospheric pressure,
a first valve chamber arranged at a first longitudinal end of the control valve body,
a second valve chamber arranged at a second longitudinal end of the control valve body, and
a fluidic valve control line comprising a discharge valve configured to discharge the lubricant from the second valve chamber to atmospheric pressure,
wherein,
the first valve chamber is directly charged with the discharge pressure,
the first valve chamber, when pressurized, is configured to push the control valve body into a low discharge pressure position against the second valve chamber, when pressurized.

16. The variable displacement lubricant pump as recited in claim 15, further comprising:
a valve spring arranged within the second valve chamber, the valve spring being configured to pretension the control valve body into a high discharge pressure position.

17. The variable displacement lubricant pump as recited in claim 15, further comprising:
a connection channel arranged within the control valve body, the connection channel being configured to directly connect the first valve chamber with the second valve chamber.

18. The variable displacement lubricant pump as recited in claim 17, further comprising:
a fluidic throttle arranged in the connection channel.

19. The variable displacement lubricant pump as recited in claim 15, further comprising:
a control unit,
wherein, the discharge valve is an electrical valve configured to be electrically controlled by the control unit.

20. The variable displacement lubricant pump as recited in claim 15, wherein the discharge valve is a proportional valve.

21. The variable displacement lubricant pump as recited in claim 15, wherein, the control valve body comprises a first piston area in the first valve chamber and a second piston area in the second valve chamber, the first piston area being larger than the second piston area.

22. The variable displacement lubricant pump as recited in claim 15, wherein the pilot chamber is directly charged with the lubricant discharge pressure.

23. The variable displacement lubricant pump as recited in claim 15, further comprising:
a first passage arranged in the control valve body; and
a pilot port arranged in the pressure control valve,
wherein,
the pilot chamber is charged with the lubricant discharge pressure via the first passage and via the pilot port in the low discharge pressure position of the control valve body, and
the pilot chamber is charged with the atmospheric pressure via the first passage and via the pilot port in a high discharge pressure position of the control valve body.

24. The variable displacement lubricant pump as recited in claim 23, further comprising:
a second passage arranged in the control valve body,
wherein,
the control chamber is charged with the lubricant discharge pressure via the second passage and by the control port in the high discharge pressure position of the control valve body, and
the control chamber is charged with the atmospheric pressure in the low discharge pressure position of the control valve body.

25. The variable displacement lubricant pump as recited in claim 24, wherein, in a medium discharge pressure position of the control valve body, the control port is connected to the lubricant discharge pressure and to atmospheric pressure.

26. The variable displacement lubricant pump as recited in claim 24, wherein, in a medium discharge pressure position of the control valve body, the pilot port (102) is connected to the lubricant discharge pressure and to atmospheric pressure.

27. The variable displacement lubricant pump as recited in claim 15, wherein,
the control chamber comprises a piston area,
the pilot chamber comprises a piston area, and
the piston area of the control chamber is larger than the piston area of the pilot chamber.

28. The variable displacement lubricant pump as recited in claim 15, further comprising:
a pretension spring configured to pretension the control ring into the high pumping volume direction.
